(19) United States
(12) Patent Application Publication
(10) Pub. No.: US 2011/0262772 A1
(43) Pub. Date: Oct. 27, 2011

(54) Method for Producing Aligned Near Full Density Pure Carbon Nanotube Sheets, Ribbons, and Films From Aligned Arrays of as Grown Carbon Nanotube Carpets/Forests and Direct Transfer to Metal and Polymer Surfaces

(75) Inventors: Robert Hauge, Houston, TX (US); Cary Pint, Albany, TX (US); Ya-Qiong Xu, Houston, TX (US); Matteo Pasquali, Houston, TX (US)

(73) Assignee: William Marsh Rice University, Houston, TX (US)

(21) Appl. No.: 12/671,644

(22) PCT Filed: Jul. 31, 2008
(86) PCT No.: PCT/US2008/071853

§ 371 Date: Mar. 7, 2011

(51) Int. Cl. B32B 19/00; C03C 25/44; B29C 67/24; B32B 37/18; B82Y 40/00

(52) U.S. Cl. 428/688; 264/175; 156/242; 216/87; 977/888

(57) ABSTRACT

Methods for preparing carbon nanotube layers are disclosed herein. Carbon nanotube layers may be films, ribbons, and sheets. The methods comprise preparing an aligned carbon nanotube array and compressing the array with a roller to create a carbon nanotube layer. Another method disclosed herein comprises preparing a carbon nanotube layer from an aligned carbon nanotube array grown on a grouping of lines of metallic catalyst. A composite material comprising at least one carbon nanotube layer and prepared by the process comprising a) compressing an aligned single-wall carbon nanotube array with a roller, and b) transferring the carbon nanotube layer to a polymer is also disclosed.

### CROSS-REFERENCE TO RELATED APPLICATIONS

This application claims priority to U.S. provisional patent application 60/953,114, filed Jul. 31, 2007, which is incorporated by reference as if written herein in its entirety.

### STATEMENT REGARDING FEDERALLY SPONSORED RESEARCH

This work was funded by Department of Energy award numbers R14790-489020 and R7A1210416000.

### BACKGROUND

Carbon nanotubes possess a number of beneficial properties, such as exceptional strength and electrical conductivity. There is substantial interest in these entities for applications in diverse fields of nanotechnology, electronic devices, optical devices and materials science. Single-wall carbon nanotubes have typically been the most studied for these proposed applications, since these nanotubes tend to offer properties which are not embodied by many of their multi-wall counterparts. The ability to rapidly grow carbon nanotubes in aligned arrays perpendicular to a growth substrate has accelerated development activities for carbon nanotube-based applications. Such perpendicular arrays of vertically aligned carbon nanotubes are sometimes referred to as carpets due to their microscopic resemblance to household carpeting. The ability to form thin, transparent carbon nanotube films has further inspired a host of hypothesized potential applications.

Films of single-wall carbon nanotubes have been prepared through vacuum filtration of solutions of surfactant-suspended single-wall carbon nanotubes. Spin coating of carbon nanotube suspensions has also been utilized to form carbon nanotube films. Exposure to air, liquids, and solvents may alter physical properties of the as-produced carbon nanotubes. Films of aligned multi-wall carbon nanotubes have been produced by drawing multi-wall carbon nanotubes from the side of a vertically aligned multi-wall carbon nanotube array.

Similarly aligned single-wall carbon nanotube films may not currently be produced by the same method due to property differences between aligned arrays of single-wall carbon nanotubes and multi-wall carbon nanotubes.

In order for carbon nanotubes to be utilized in applications and devices, it may be beneficial to separate carbon nanotube arrays and films derived thereof from their growth surfaces. An array of carbon nanotubes may be separated from its growth surface by immersing the as-grown carbon nanotube array in hot water, providing separation based on a thermocapillary effect. Capillary forces present during the drying process may disrupt carbon nanotube alignment and affect physical properties of arrays separated from their growth surfaces in this manner. Mechanical force may also be utilized to separate carbon nanotubes and films derived thereof from their growth surfaces.

In view of the foregoing, development of simple methods for forming single-wall carbon nanotube films from aligned single-walled carbon nanotube arrays would be of considerable utility. Further, methods not requiring a wet chemical processing step for separation of the aligned carbon nanotube arrays and films would be beneficial.

### SUMMARY

In some aspects, the present disclosure provides a method for producing a carbon nanotube layer. The method comprises compressing an array comprising a plurality of carbon nanotubes. Compressing the array comprises passing a roller over the array.

In other aspects, the present disclosure provides a method for preparing a carbon nanotube layer, wherein the layer comprises a plurality of aligned carbon nanotubes. The method comprises the steps of a) preparing an array comprising a plurality of vertically aligned carbon nanotubes; b) cooling the array in a gaseous mixture comprising a carbon source and H₂O; c) compressing the array with a roller to create a carbon nanotube layer, wherein the layer comprises a plurality of aligned carbon nanotubes; and d) treating the layer with an acid.

In another aspect, the present disclosure provides a method for preparing a carbon nanotube layer, wherein the layer comprises a plurality of aligned carbon nanotubes. The method comprises the steps of a) preparing an array comprising a plurality of vertically aligned carbon nanotubes; b) heating the array in a gaseous mixture comprising an etchant; and c) compressing the array with a roller to create a carbon nanotube layer, wherein the layer comprises a plurality of aligned carbon nanotubes.

In still another aspect, the present disclosure provides a method for preparing a carbon nanotube layer, wherein the layer comprises a plurality of aligned carbon nanotubes. The method comprises the steps of: a) preparing a carbon nanotube growth surface, wherein the growth surface comprises an grouping of lines comprising a metallic catalyst; b) growing an array comprising a plurality of vertically aligned carbon nanotubes on the grouping, wherein the height of the plurality of vertically aligned carbon nanotubes is greater than the separation between lines in the grouping; and c) compressing the array with a roller to create a carbon nanotube layer, wherein the layer comprises a plurality of aligned carbon nanotubes.

In yet another aspect, the present disclosure provides a composite material comprising at least one single-wall carbon nanotube layer, wherein the layer comprises a plurality of aligned single-wall carbon nanotubes, and wherein the composite material is prepared by the process comprising the steps of: a) preparing an array comprising a plurality of vertically aligned single-wall carbon nanotubes; b) heating the array in a gaseous mixture comprising an etchant; c) compressing the array with a roller to create a carbon nanotube layer, wherein the layer comprises a plurality of aligned single-wall carbon nanotubes; and d) transferring the layer to a polymer.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

The foregoing summary as well as the following detailed description of the disclosure will be better understood when read in conjunction with the appended drawings. It should be understood that the disclosure is not limited to the precise arrangements and instrumentalities shown herein. The components in the drawings are not necessarily to scale, emphasis instead being placed upon clearly illustrating the principles and certain embodiments of the present disclosure. For a more complete understanding of the present disclosure, and the advantages thereof, reference is now made to the following descriptions to be taken in conjunction with the accompanying drawings describing a specific embodiment of the disclosure, wherein:

FIG. 1 shows an embodiment of the method for producing a carbon nanotube layer by compressing a carbon nanotube array with a roller.

FIG. 2 shows representative SEM images of a carbon nanotube array before and after compressing with a roller to produce a carbon nanotube film.

FIG. 3 shows an embodiment of a carbon nanotube film before, during, and after wet chemical detachment of the film.

FIG. 4 shows images of an embodiment of single-wall carbon nanotube films attached to stainless steel, copper, and polyethylene host surfaces.

FIG. 5 illustrates a proposed mechanism for the differences in release properties of carbon nanotube layers prepared from carbon nanotube arrays processed under various conditions prior to compressing.

FIG. 6 shows a plot of the percent transparency at 550 nm for embodiments of single-wall carbon nanotube films and an embodiment of a double-wall carbon nanotube film grown under different conditions as a function of growth time.

FIG. 7 shows a representative SEM image for an embodiment of a single-wall carbon nanotube array. The array comprises 2 μm wide lines of vertically aligned single-wall carbon nanotubes, where the lines are separated by 50 μm. The inset is a high magnification image of the edge of a single line.

FIG. 8 shows a representative SEM image for an embodiment of a single-wall carbon nanotube film prepared by compressing the array of vertically aligned single-wall carbon nanotubes shown in FIG. 7.

FIG. 9 shows representative 633 nm polarized Raman spectra of the D and G bands for a single-wall carbon nanotube array (as measured from the side of the array) and for a carbon nanotube film formed by compressing the array through rolling (as measured from the top of the film).

FIG. 10 shows representative SEM images for an embodiment of a vertically aligned single-wall carbon nanotube array before and after compressing with a roller to create a carbon nanotube film.

FIG. 11 shows a representative SEM image for an embodiment of a single-wall carbon nanotube array after capillary-force induced drying, wherein the array has not been heated in a gaseous mixture comprising an etchant after growth. The inset shows increased magnification of a region of the main image.

FIG. 12 shows a representative SEM image for an embodiment of a single-wall carbon nanotube array after capillary-force induced drying, wherein the array has been heated in a gaseous mixture comprising H₂O and H₂ after growth. The inset shows increased magnification of a region of the main image.

FIG. 13 shows comparative core-level Fe (Fe2P_{3/2}) XPS spectra for a) as-deposited Fe/Al₂O₃ catalyst/substrate; b) residual Fe catalyst layer after cooling of an embodiment of a single-wall carbon nanotube array in C₂H₂, H₂O, and H₂, compressing to make a film, and removing the carbon nanotube film; and c) residual Fe catalyst layer after cooling of an embodiment of a single-wall carbon nanotube array in C₂H₂, H₂O, and H₂, heating the prepared single-wall carbon nanotube array in a gaseous mixture comprising H₂O and H₂ after growth, compressing to make a film, and removing the carbon nanotube film.

### DETAILED DESCRIPTION

In the following description, certain details are set forth such as specific quantities, sizes, etc. so as to provide a thorough understanding of the present embodiments disclosed herein. However, it will be obvious to those skilled in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing a particular embodiment of the disclosure and are not intended to be limiting thereto.

While most of the terms used herein will be recognizable to those of skill in the art, the following definitions are nevertheless put forth to aid in the understanding of the present disclosure. It should be understood, however, that when not explicitly defined, terms should be interpreted as adopting a meaning presently accepted by those of skill in the art.

“Array,” as defined herein, comprises a prepared assembly of carbon nanotubes. As used herein, an array of carbon nanotubes refers to carbon nanotube forests and carbon nanotube carpets. Arrays may be formed from patterned growth surfaces.

“Carbon nanotube layer,” as defined herein, refers to a film, ribbon, or sheet of carbon nanotubes.

“Host surface,” as defined herein, comprises a surface to which a carbon nanotube layer is transferred.

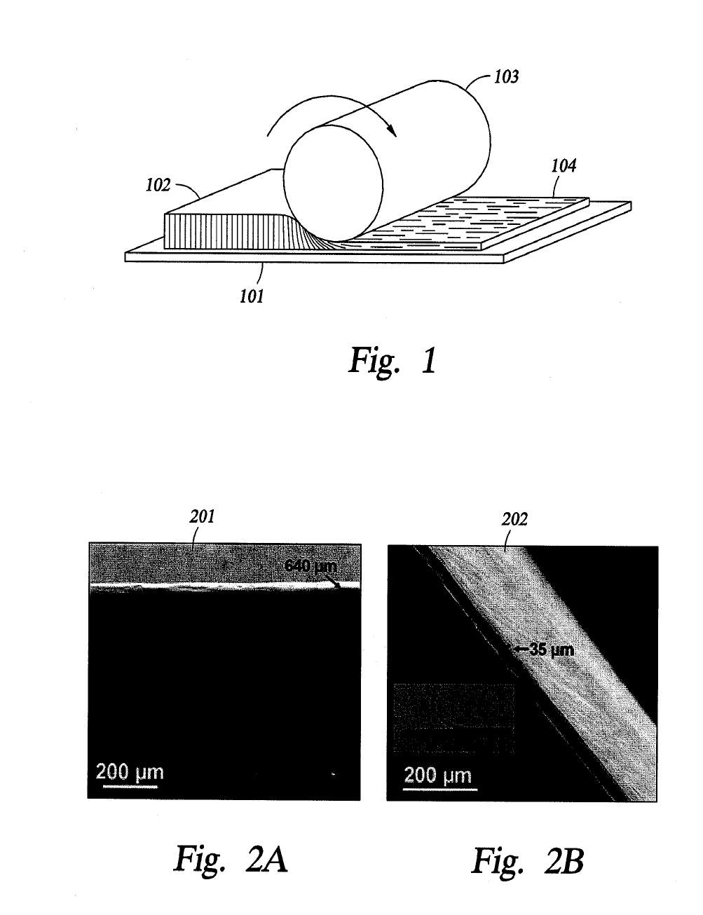

In the most general aspects, the present disclosure provides a method for producing a carbon nanotube layer. The method comprises compressing an array, wherein the array comprises a plurality of carbon nanotubes. Compressing the array comprises passing a roller over the array. In some embodiments of the method, the carbon nanotube layer comprises a film. In other embodiments of the method, the carbon nanotube layer comprises a ribbon. In still other embodiments, the carbon nanotube layer comprises a sheet. As illustrated in FIG. 1, an embodiment of the method shows an array of carbon nanotubes 102 deposited on a surface 101. A roller 103 is then passed over the array of carbon nanotubes 102. The rolling step lays over the carbon nanotubes to produce a carbon nanotube film 104. FIG. 2 shows an SEM image 201 of the carbon nanotube array before compressing and a comparative SEM image 202 after compressing to make a film. In certain embodiments of the method, at least a portion of the plurality of carbon nanotubes comprising the array are vertically aligned. In some embodiments, the carbon nanotubes comprising the array are vertically aligned. According to some embodiments, one or more carbon nanotubes in a vertically aligned array may vary locally in inclination from top to bottom from about 0 degrees to about 30 degrees. According to some embodiments, one or more carbon nanotubes in a vertically aligned array may vary locally in inclination from top to bottom from between about 0 degrees and about 10 degrees. According to some embodiments, one or more carbon nanotubes in a vertically aligned array may vary locally in inclination from top to bottom from between about 0 degrees and about 5 degrees. Carbon nanotubes may comprise at least one component selected from the group including, but not limited to single-wall carbon nanotubes, double-wall carbon nanotubes, multi-wall carbon nanotubes, and combinations thereof. During the compressing step of passing a roller over the carbon nanotube array, the carbon layer so produced may stay attached to the surface on which the carbon nanotube array is grown, or it may be transferred to the roller. A compressed carbon nanotube layer not removed in the compressing process may optionally be removed at a later time through additional processing. Transferability of the carbon nanotube layer may be determined by the way in which the carbon nanotube array is processed after growth.

The method of compressing an array comprising a plurality of carbon nanotubes is advantageous in that a highly dense layer of carbon nanotubes may be produced from a low density array of carbon nanotubes. In a non-limiting example, an array of carbon nanotubes having a nanotube diameter of about 1 nm and a spacing between nanotubes of about 10 nm can be compressed by a factor of about 25, yielding a nearly full density carbon nanotube film. Prior to compressing, such an array has a density of only about 4% of the maximum possible. One skilled in the art will recognize that the thickness and density of the carbon nanotube layer produced following the compressing step will depend both on the height and spacing of the carbon nanotubes comprising the array. Many proposed applications of carbon nanotube layers are best suited for near full density structures, and the methods disclosed herein provide a simple means to meet that need.

The method for producing a carbon nanotube layer further comprises transferring the carbon nanotube layer to a host surface. Carbon nanotube layers may be transferred to an number of host surfaces, including but not limited to, Cu, Al, Ta, and stainless steel. The host surfaces may include, but are not limited to, foils, films, and blocks. The carbon nanotube layers may also be transferred to polymer films, including thermoplastic and epoxy polymer films, in non-limiting examples. Polymer blocks may also serve as the host surface. Likewise, carbon nanotube layers may be transferred to a polymer precursor, the polymer then being formed after transfer of the carbon nanotube layer. When the carbon nanotube layer is transferred to a polymer, the resultant material comprises a polymer composite comprising carbon nanotubes. In a representative but non-limiting embodiment of the disclosure, carbon nanotube layers may be transferred to a polyethylene film. Carbon nanotube layers may also be transferred to polished surfaces, such as quartz, sapphire, and glass, in non-limiting examples.

In certain embodiments of the method for producing a carbon nanotube layer, the carbon nanotubes comprising the layer are aligned. In some embodiments, the carbon nanotubes are aligned and parallel to the surface of the layer. In certain embodiments, at least a portion of the carbon nanotubes are aligned and parallel to the surface of the layer. According to some embodiments, one or more carbon nanotubes parallel to the surface of the carbon nanotube layer may deviate from the plane of the layer from about 0 degrees to about 20 degrees. According to some embodiments, one or more carbon nanotubes parallel to the surface of the carbon nanotube layer may deviate from the plane of the layer from about 0 degrees to about 10 degrees. According to some embodiments, one or more carbon nanotubes parallel to the surface of the carbon nanotube layer may deviate from the plane of the layer from about 0 degrees to about 5 degrees. Alignment of carbon nanotubes comprising the layer may be determined by alignment of the carbon nanotube array compressed to form the layer. In certain embodiments, the carbon nanotube layer maintains about 99% of the alignment present in the carbon nanotube array. In other embodiments, the carbon nanotube layer maintains about 97% of the alignment present in the carbon nanotube array. In other embodiments, the carbon nanotube layer maintains about 95% of the alignment present in the carbon nanotube array. In other embodiments, the carbon nanotube layer maintains about 90% of the alignment present in the carbon nanotube array. In other embodiments, the carbon nanotube layer maintains about 80-90% of the alignment present in the carbon nanotube array. In other embodiments, the carbon nanotube layer maintains about 70-80% of the alignment present in the carbon nanotube array. In other embodiments, the carbon nanotube layer maintains about 60-70% of the alignment present in the carbon nanotube array. In other embodiments, the carbon nanotube layer maintains about 50-60% of the alignment present in the carbon nanotube array. In other embodiments, the carbon nanotube layer maintains about 40-50% of the alignment present in the carbon nanotube array. In other embodiments, the carbon nanotube layer maintains about 30-40% of the alignment present in the carbon nanotube array. In other embodiments, the carbon nanotube layer maintains about 20-30% of the alignment present in the carbon nanotube array. In other embodiments, the carbon nanotube layer maintains about 10-20% of the alignment present in the carbon nanotube array. In certain embodiments of the method, transferring the carbon nanotube layer to a host surface maintains alignment of at least a portion of the carbon nanotubes.

Another aspect of the present disclosure is a method for preparing a carbon nanotube layer comprising a plurality of aligned carbon nanotubes. The method comprises the steps of: a) preparing an array comprising a plurality of vertically aligned carbon nanotubes; b) cooling the array in a gaseous mixture comprising a carbon source and H₂O; c) compressing the array with a roller to create a carbon nanotube layer, wherein the layer comprises a plurality of aligned carbon nanotubes; and d) treating the layer with an acid. In an embodiment of the method, the layer comprises a film. In another embodiment of the method, the layer comprises a ribbon. In an embodiment of the method, preparing an array, wherein the array comprises a plurality of vertically aligned carbon nanotubes, takes place in the presence of a metallic catalyst (step a). Suitable metallic catalysts for directing carbon nanotube growth may include, but are not limited to, at least one metal selected from Groups 3-12 of the periodic table, the lanthanide elements, and combinations thereof. In an embodiment of the method, the metallic catalyst is Fe deposited on an Al₂O₃ growth surface. Suitable carbon sources for practicing the method may include, but are not limited to, at least one compound selected from the group consisting of methane, ethane, propane, butane, isobutane, ethylene, propene, 1-butene, cis-2-butene, trans-2-butene, isobutylene, acetylene, propyne, 1-butyne, 2-butyne, benzene, toluene, carbon monoxide, methanol, ethanol, 1-propanol, 2-propanol, 1-butanol, 2-butanol, 2-methyl-2-propanol, cyclopropane, cyclobutane, acetonitrile, propionitrile, butyronitrile, acetone, butanone, formaldehyde, acetaldehyde, propionaldehyde, and butyraldehyde. In an embodiment, the carbon source comprises acetylene. In another embodiment of the method, the carbon nanotubes comprise single-wall carbon nanotubes.

In some embodiments of the method, the carbon nanotubes are aligned and parallel to the surface of the layer. In certain embodiments of the method, at least a portion of the carbon nanotubes are aligned and parallel to the surface of the layer. According to some embodiments, one or more carbon nanotubes parallel to the surface of the carbon nanotube layer may deviate from the plane of the layer from about 0 degrees to about 20 degrees. According to some embodiments, one or more carbon nanotubes parallel to the surface of the carbon nanotube layer may deviate from the plane of the layer from about 0 degrees to about 10 degrees. According to some embodiments, one or more carbon nanotubes parallel to the surface of the carbon nanotube layer may deviate from the plane of the layer from about 0 degrees to about 5 degrees. Alignment of carbon nanotubes comprising the layer may be determined by alignment of the carbon nanotube array compressed to form the layer. In certain embodiments, the carbon nanotube layer maintains about 99% of the alignment present in the carbon nanotube array. In other embodiments, the carbon nanotube layer maintains about 97% of the alignment present in the carbon nanotube array. In other embodiments, the carbon nanotube layer maintains about 95% of the alignment present in the carbon nanotube array. In other embodiments, the carbon nanotube layer maintains about 90% of the alignment present in the carbon nanotube array. In other embodiments, the carbon nanotube layer maintains about 80-90% of the alignment present in the carbon nanotube array. In other embodiments, the carbon nanotube layer maintains about 70-80% of the alignment present in the carbon nanotube array. In other embodiments, the carbon nanotube layer maintains about 60-70% of the alignment present in the carbon nanotube array. In other embodiments, the carbon nanotube layer maintains about 50-60% of the alignment present in the carbon nanotube array. In other embodiments, the carbon nanotube layer maintains about 40-50% of the alignment present in the carbon nanotube array. In other embodiments, the carbon nanotube layer maintains about 30-40% of the alignment present in the carbon nanotube array. In other embodiments, the carbon nanotube layer maintains about 20-30% of the alignment present in the carbon nanotube array. In other embodiments, the carbon nanotube layer maintains about 10-20% of the alignment present in the carbon nanotube array. In certain embodiments of the method, transferring the carbon nanotube layer to a host surface maintains alignment of at least a portion of the carbon nanotubes.

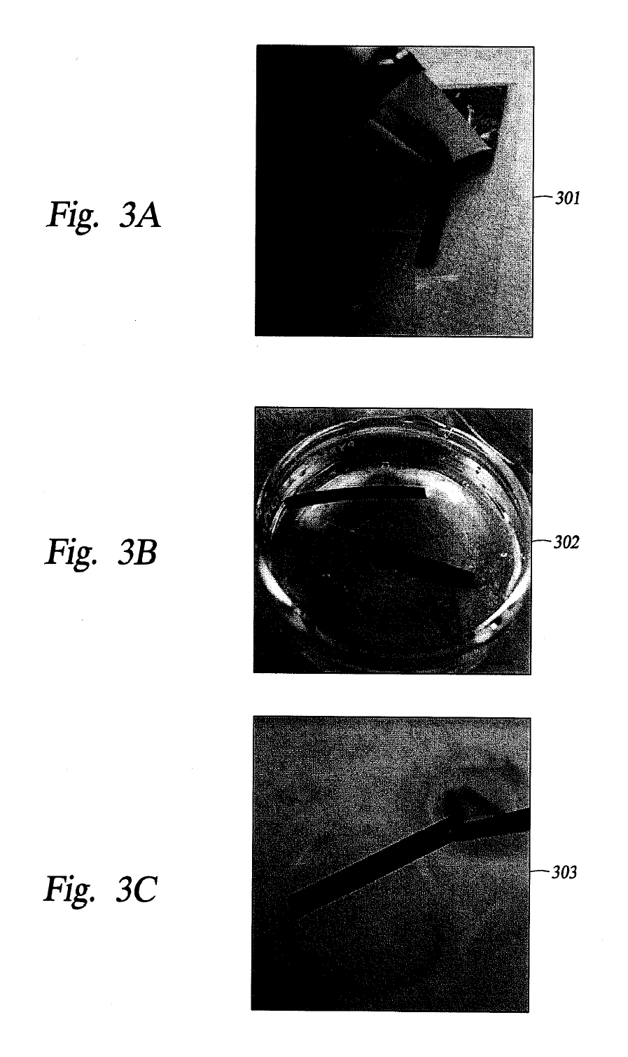

Carbon nanotube films prepared by the method described hereinabove may maintain strong adherence to the growth surface prior to the acid treatment step. Without being bound by mechanism or theory, it is believed that the acid treatment step etches the metallic catalyst particles and results in detachment of the carbon nanotube film from the growth surface. The freestanding carbon nanotube layer is released within a matter of seconds when the as-produced layer is treated with a 1 M HCl etch. FIG. 3 shows an as-produced carbon nanotube film in image 301 being removed from the growth surface on to adhesive tape prior to acid treatment. A like carbon nanotube film may be released in several seconds by 1 M HCl treatment to produce a free standing carbon nanotube film as shown in image 302. Image 303 shows the freestanding carbon nanotube film supporting its own weight after removal from the acid treatment bath shown in image 302.

Still another aspect of the present disclosure is a method for preparing a carbon nanotube layer comprising a plurality of aligned carbon nanotubes. The method comprises the steps of a) preparing an array comprising a plurality of vertically aligned carbon nanotubes; b) heating the array in a gaseous mixture comprising an etchant; and c) compressing the array with a roller to create a carbon nanotube layer, wherein the layer comprises a plurality of aligned carbon nanotubes. In an embodiment of the method, the layer comprises a film. In another embodiment of the method, the layer comprises a ribbon. In an embodiment, preparing an array, wherein the array comprises a plurality of vertically aligned carbon nanotubes, takes place in the presence of a metallic catalyst (step a). Suitable metallic catalysts for directing carbon nanotube growth may include, but are not limited to at least one metal selected from Groups 3-12 of the periodic table, the lanthanide elements, and combinations thereof In an embodiment of the method, the metallic catalyst is Fe deposited on an Al₂O₃ growth surface. Suitable etchants for practicing the method may include at least one component selected from the group, including but not limited to, H₂O, H₂O₂, H₂, organic peroxides, and oxidizing acids. In an embodiment of the method, the etchant comprises H₂O. In another embodiment of the method, the etchant comprises a mixture comprising H₂O and H₂. In another embodiment of the method, the carbon nanotubes comprise single-wall carbon nanotubes.

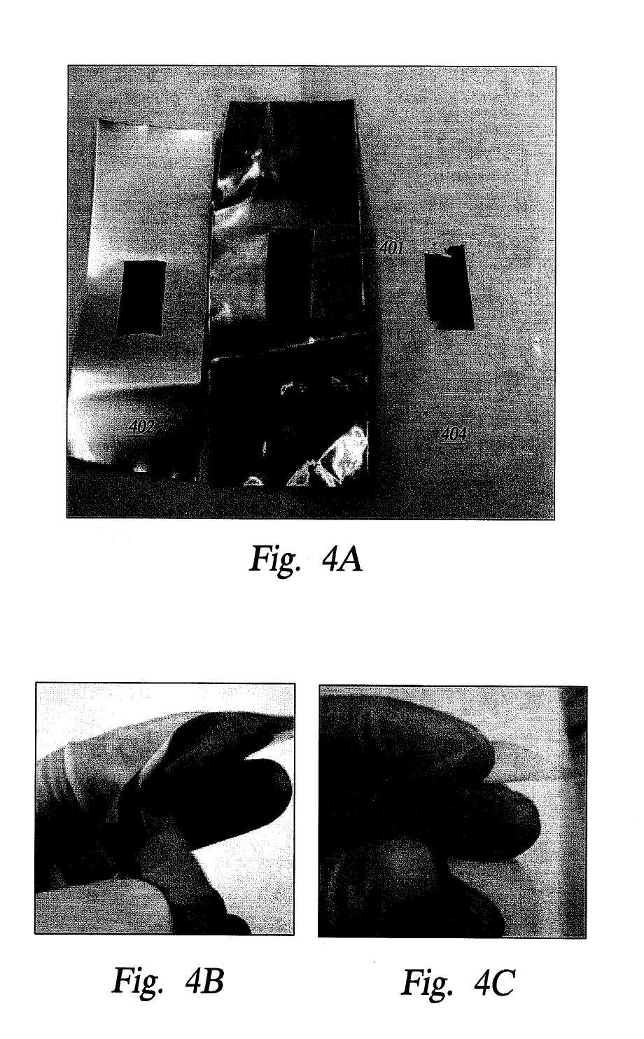

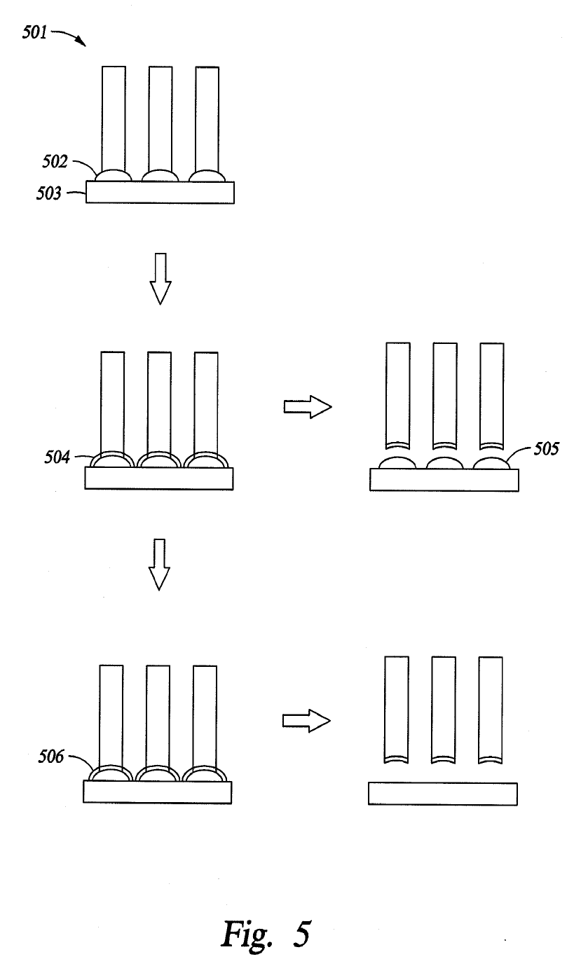

The method of preparing a carbon nanotube layer comprising aligned carbon nanotubes and disclosed immediately hereinabove may be further comprised by transferring the layer (step d). The transferring step may be to a host surface placed on the layer comprising aligned carbon nanotubes following the compressing step. Such host surfaces may include polished host surfaces including, but not limited to, quartz, sapphire, and glass. In an embodiment of the method, the transferring step occurs during the compressing step and the transferring is to a host surface covering the roller. The host surface may cover the roller as a film or a foil in an embodiment. A wide range of host surfaces may be suitable for transfer of the carbon nanotube layer to them. Host surfaces may include, but are not limited to, foils, films, and blocks. Representative host surfaces that may receive carbon nanotube layers when the host surfaces cover the roller may include, but are not limited to, Cu, Al, Ta, and stainless steel foils. The carbon nanotube layers may also be transferred to polymer films, including thermoplastic and epoxy polymer films, in non-limiting examples. Polymer blocks may also serve as the host surface. Likewise, carbon nanotube layers may be transferred to a polymer precursor, the polymer then being formed after transfer of the carbon nanotube layer. In a representative but non-limiting embodiment of the disclosure, carbon nanotube layers may be transferred to a polyethylene film. FIG. 4 shows a carbon nanotube film 401 transferred to various host surfaces. Images 402, 403, and 404 respectively show carbon nanotube films transferred on to stainless steel foil, copper foil, and polyethylene film host surfaces.

In some embodiments, the carbon nanotubes are aligned and parallel to the surface of the layer. In certain embodiments, at least a portion of the carbon nanotubes are aligned and parallel to the surface of the layer. According to some embodiments, one or more carbon nanotubes parallel to the surface of the carbon nanotube layer may deviate from the plane of the layer from about 0 degrees to about 20 degrees. According to some embodiments, one or more carbon nanotubes parallel to the surface of the carbon nanotube layer may deviate from the plane of the layer from about 0 degrees to about 10 degrees. According to some embodiments, one or more carbon nanotubes parallel to the surface of the carbon nanotube layer may deviate from the plane of the layer from about 0 degrees to about 5 degrees. Alignment of carbon nanotubes comprising the layer may be determined by alignment of the carbon nanotube array compressed to form the layer. In certain embodiments, the carbon nanotube layer maintains about 99% of the alignment present in the carbon nanotube array.

In other embodiments, the carbon nanotube layer maintains about 97% of the alignment present in the carbon nanotube array. In other embodiments, the carbon nanotube layer maintains about 95% of the alignment present in the carbon nanotube array. In other embodiments, the carbon nanotube layer maintains about 90% of the alignment present in the carbon nanotube array. In other embodiments, the carbon nanotube layer maintains about 80-90% of the alignment present in the carbon nanotube array. In other embodiments, the carbon nanotube layer maintains about 70-80% of the alignment present in the carbon nanotube array. In other embodiments, the carbon nanotube layer maintains about 60-70% of the alignment present in the carbon nanotube array. In other embodiments, the carbon nanotube layer maintains about 50-60% of the alignment present in the carbon nanotube array. In other embodiments, the carbon nanotube layer maintains about 40-50% of the alignment present in the carbon nanotube array. In other embodiments, the carbon nanotube layer maintains about 30-40% of the alignment present in the carbon nanotube array. In other embodiments, the carbon nanotube layer maintains about 20-30% of the alignment present in the carbon nanotube array. In other embodiments, the carbon nanotube layer maintains about 10-20% of the alignment present in the carbon nanotube array. In certain embodiments of the method, transferring the carbon nanotube layer to a host surface maintains alignment of at least a portion of the carbon nanotubes.

Without being bound by theory or mechanism, it is believed that the heating step in an etchant of the method disclosed hereinabove etches the catalyst particles and allows the carbon nanotubes to be easily removed from the growth surface through simple contact and transfer to a host surface. This dry processing method for detaching carbon nanotube layers from the growth surface is advantageous in that it avoids capillary forces during drying. Said capillary forces may lower the alignment factor of the carbon nanotubes comprising a carbon nanotube film released by a wet chemical etch. Such a dry processing treatment is further advantageous in that it may not affect carbon nanotube alignment either before or after the compressing step. It is further distinguishable in that it avoids residual acid, solvent, or surfactant remaining in the film so produced. In an embodiment of the method for dry processing of a carbon nanotube layer, the carbon nanotube array is heated in the presence of an etchant for about 1 minute to about 60 minutes at a temperature of about 500° C. to about 1000° C. In other embodiments, the heating step in the presence of an etchant is conducted for about 2 minutes to about 30 minutes at a temperature of about 600° C. to about 900° C. In still other embodiments, the heating step in the presence of an etchant is conducted for about 3 minutes to about 10 minutes at a temperature of about 700° C. to about 850° C. In an embodiment, the etchant is H₂O. Optional inclusion of H₂ in the mixture comprising the etchant may be advantageous in certain instances. In a representative, but non-limiting example, the heating of an as-produced carbon nanotube array is conducted at about 775° C. for about 5 minutes in order to prepare the array for compressing and release of the so-produced carbon nanotube film by simple contact with a host surface.

A comparison of the presumptive mechanisms by which heat treatment in the presence of an etchant and acid treatment result in release of carbon nanotube layers from the growth surface is shown in FIG. 5. An array of carbon nanotubes 501 is supported on catalyst particles 502, which is in contact with growth surface 503. Cooling of the carbon nanotube array in the presence of a gaseous mixture comprising a carbon source, H₂O and H₂ produces carbon-overcoated catalyst particles 504. The carbon source may comprise acetylene in an embodiment. Treatment of the carbon-overcoated catalyst particles 504 by heating in an etchant may remove the carbon shell to provide a loosely-bound array of carbon nanotubes 507 and oxidized catalyst particles 505, such as an iron oxide. If carbon-overcoated catalyst particles 504 are oxidized in air, oxidized catalyst particles overcoated with a carbon shell 506 results, such as an iron oxide overcoated with a carbon shell. Acid treatment of the carbon nanotube array containing oxidized catalyst particles overcoated with a carbon shell 506 may remove the oxidized catalyst particles and the carbon shell overcoating to provide a loosely-bound array of carbon nanotubes 508. Further characterization of these proposed release mechanisms is provided as an experimental example hereinafter.

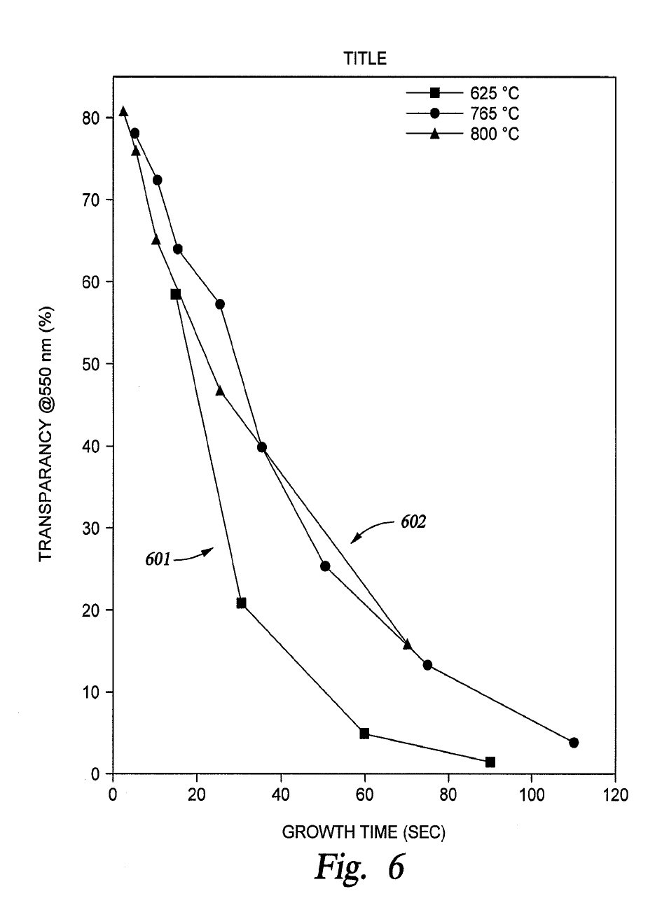

The dry processing method disclosed hereinabove may provide aligned carbon nanotube films having variable transparency depending on the time the carbon nanotube array is allowed to grow. Further, depending on the temperature at which the carbon nanotube array is grown, arrays comprised of a plurality of single-wall carbon nanotubes or a plurality of double-wall carbon nanotubes may be prepared. Films produced from the single-wall carbon nanotube arrays and double-wall carbon nanotube arrays have variable transparency. Single-wall carbon nanotube arrays were grown at about 765° C. and about 800° C., and double-wall carbon nanotube arrays were grown at about 625° C. Heating of these carbon nanotube arrays in the presence of an etchant at about 775° C. gave carbon nanotube films after compressing that were transferred to a polyethylene host surface. FIG. 6 shows the variance in transparency of these films at 550 nm as a function of growth time. Single-wall carbon nanotube films 602 were more transparent than were double-wall carbon nanotube films 601 having the same growth time as shown in FIG. 6.

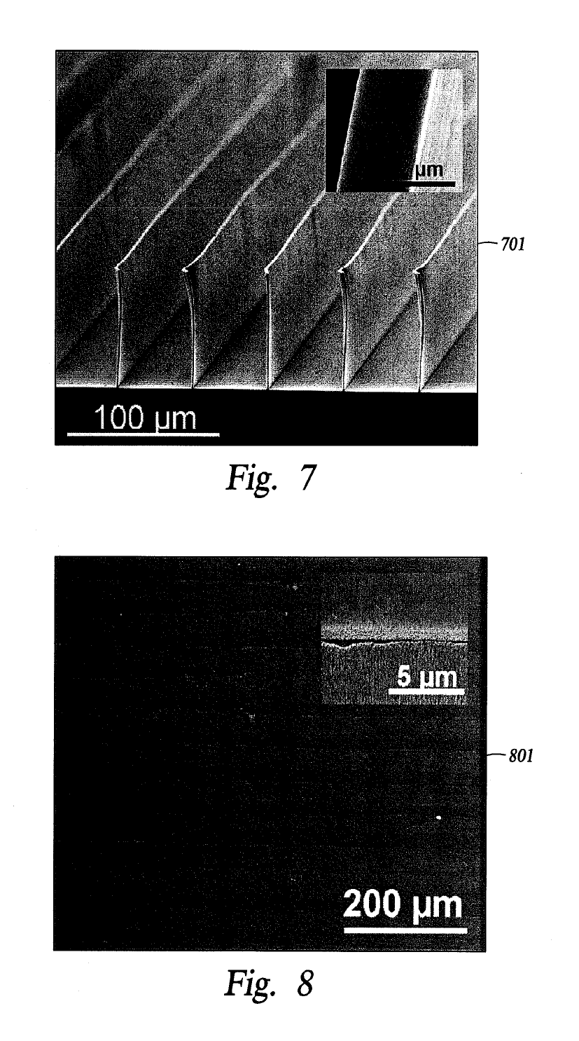

Yet another aspect of the present disclosure is a method for preparing a layer comprising a plurality of aligned carbon nanotubes. The method comprises the steps of a) preparing a carbon nanotube growth surface, wherein the growth surface comprises a grouping of lines comprising a metallic catalyst; b) growing an array comprising a plurality of vertically aligned carbon nanotubes, wherein growing occurs on the grouping of lines, and wherein the height of the plurality of vertically aligned carbon nanotubes is greater than the separation between lines in the grouping of lines; and c) compressing the array with a roller to create a carbon nanotube layer, wherein the layer comprises a plurality of aligned carbon nanotubes. Lithography offers a means to prepare a patterned growth surface having a grouping of lines comprising the metallic catalyst for carbon nanotube growth. In an embodiment of the method, the layer comprises a film. In another embodiment of the method, the layer comprises a ribbon. Suitable metallic catalysts for directing carbon nanotube growth may include, but are not limited to at least one metal selected from Groups 3-12 of the periodic table, the lanthanide elements, and combinations thereof. In an embodiment of the method, the metallic catalyst is Fe deposited as a grouping of lines on an Al₂O₃ growth surface. In a representative but non-limiting example of the method disclosed hereinabove, metallic catalyst lines about 2 μm wide and separated by about 50 μm may be used to grow self-supporting aligned carbon nanotube arrays to a height of about 70 μm. FIG. 7 shows a side-view SEM image 701 of a single-wall carbon nanotube array grown as described hereinabove.

The method disclosed hereinabove may be further comprised by heating the array, wherein the array comprises a plurality of vertically aligned carbon nanotubes, in a gaseous mixture comprising an etchant prior to the compressing step (step c). Suitable etchants for practicing the method may include at least one component selected from the group, including but not limited to, H₂O, H₂O₂, H₂, organic peroxides, and oxidizing acids. In an embodiment, the etchant comprises H₂O. In another embodiment, the etchant comprises a mixture comprising H₂O and H₂. In an embodiment of the method, the carbon nanotube array is heated in the presence of an etchant for about 1 minute to about 60 minutes at a temperature of about 500° C. to about 1000° C. In other embodiments, the heating step in the presence of an etchant is conducted for about 2 minutes to about 30 minutes at a temperature of about 600° C. to about 900° C. In still other embodiments, the heating step in the presence of an etchant is conducted for about 3 minutes to about 10 minutes at a temperature of about 700° C. to about 850° C. In certain embodiments of the method, the heating step is conducted in the presence of a mixture comprising H₂O and H₂ for about 5 minutes at a temperature of about 775° C. The method disclosed hereinabove may also be further comprised by removing the carbon nanotube layer from the growth surface (step d). Removing the carbon nanotube layer may be facilitated as a result of heating in the presence of an etchant or by acid treatment following compression. In embodiments of the method, at least a portion of the carbon nanotubes are aligned following the compressing step. FIG. 8 shows a top-view SEM image 801 following compressing the carbon nanotube array grown as described hereinabove, which shows overlap of carbon nanotubes from adjacent lines following compressing. SEM image 801 also shows maintaining of the alignment of the carbon nanotubes in the carbon nanotube film. Maintenance of alignment in this film is also supported by polarized Raman spectra which demonstrates greater than about 90% alignment of the carbon nanotubes in the carbon nanotube film. An uncertainty of about 5% in the measurement of the alignment by the polarized Raman method arises as a result of aligning the laser during measurement.

In some embodiments, the carbon nanotubes are aligned and parallel to the surface of the layer. In certain embodiments, at least a portion of the carbon nanotubes are aligned and parallel to the surface of the layer. According to some embodiments, one or more carbon nanotubes parallel to the surface of the carbon nanotube layer may deviate from the plane of the layer from about 0 degrees to about 20 degrees. According to some embodiments, one or more carbon nanotubes parallel to the surface of the carbon nanotube layer may deviate from the plane of the layer from about 0 degrees to about 10 degrees. According to some embodiments, one or more carbon nanotubes parallel to the surface of the carbon nanotube layer may deviate from the plane of the layer from about 0 degrees to about 5 degrees. Alignment of carbon nanotubes comprising the layer may be determined by alignment of the carbon nanotube array compressed to form the layer. In certain embodiments, the carbon nanotube layer maintains about 99% of the alignment present in the carbon nanotube array. In other embodiments, the carbon nanotube layer maintains about 97% of the alignment present in the carbon nanotube array. In other embodiments, the carbon nanotube layer maintains about 95% of the alignment present in the carbon nanotube array. In other embodiments, the carbon nanotube layer maintains about 90% of the alignment present in the carbon nanotube array. In other embodiments, the carbon nanotube layer maintains about 80-90% of the alignment present in the carbon nanotube array. In other embodiments, the carbon nanotube layer maintains about 70-80% of the alignment present in the carbon nanotube array. In other embodiments, the carbon nanotube layer maintains about 60-70% of the alignment present in the carbon nanotube array. In other embodiments, the carbon nanotube layer maintains about 50-60% of the alignment present in the carbon nanotube array. In other embodiments, the carbon nanotube layer maintains about 40-50% of the alignment present in the carbon nanotube array. In other embodiments, the carbon nanotube layer maintains about 30-40% of the alignment present in the carbon nanotube array. In other embodiments, the carbon nanotube layer maintains about 20-30% of the alignment present in the carbon nanotube array. In other embodiments, the carbon nanotube layer maintains about 10-20% of the alignment present in the carbon nanotube array. In certain embodiments of the method, transferring the carbon nanotube layer to a host surface maintains alignment of at least a portion of the carbon nanotubes.

In additional embodiments of the method for forming a carbon nanotube layer, the carbon nanotubes comprise single-wall carbon nanotubes. Carbon nanotube layers comprised of aligned carbon nanotubes, as produced by the method hereinabove, are advantageous in being inherently thin as a result of the spacing between catalyst lines on the patterned growth surface. One skilled in the art will recognize that the spacing between catalyst lines may be varied, along with the height to which the carbon nanotube array is grown, in order to vary the layer thickness and degree of overlap between adjacent carbon nanotube lines.

In an additional aspect, the present disclosure also describes a composite material comprising at least one single-wall carbon nanotube layer, wherein the layer comprises a plurality of aligned single-wall carbon nanotubes, and wherein the composite material is prepared by the process comprising the steps of: a) preparing an array comprising a plurality of vertically aligned single-wall carbon nanotubes; b) heating the array in a gaseous mixture comprising an etchant; c) compressing the array with a roller to create a carbon nanotube layer, wherein the layer comprises a plurality of aligned single-wall carbon nanotubes; and d) transferring the layer to a polymer. Suitable etchants may include at least one component selected from the group, including but not limited to, H₂O, H₂O₂, H₂, organic peroxides, and oxidizing acids. In an embodiment of the composite material prepared by the process disclosed hereinabove, the etchant comprises H₂O. In another embodiment of the composite material prepared by the process disclosed hereinabove, the etchant comprises a mixture comprising H₂O and H₂. The composite material prepared by the process disclosed hereinabove may further comprise coating the roller with a polymer film prior to the compressing step (step c). Coating the roller with a polymer film prior to the compressing step may allow transfer of the carbon nanotube layer produced during the compressing step directly to the polymer film. In a further embodiment, the composite material may comprise a laminate composite. In such an embodiment, the composite material prepared by the process disclosed hereinabove further comprises alternating sheets of polymer film and aligned single-wall carbon nanotube layers. Laminate composites may be prepared with the carbon nanotube layers aligned in the same direction. Laminate composites may also be prepared with the carbon nanotube layers arranged in alternating orthogonal layers between sheets of polymer to provide enhanced strength in lateral directions.

In some embodiments of the composite material, the single-wall carbon nanotubes are aligned and parallel to the surface of the layer. In certain embodiments of the composite material, at least a portion of the single-wall carbon nanotubes are aligned and parallel to the surface of the layer. According to some embodiments of the composite material, one or more single-wall carbon nanotubes parallel to the surface of the carbon nanotube layer may deviate from the plane of the layer from about 0 degrees to about 20 degrees. According to some embodiments of the composite material, one or more single-wall carbon nanotubes parallel to the surface of the carbon nanotube layer may deviate from the plane of the layer from about 0 degrees to about 10 degrees. According to some embodiments of the composite material, one or more single-wall carbon nanotubes parallel to the surface of the carbon nanotube layer may deviate from the plane of the layer from about 0 degrees to about 5 degrees. Alignment of single-wall carbon nanotubes comprising the layer may be determined by alignment of the single-wall carbon nanotube array compressed to form the layer. In certain embodiments of the composite material, the single-wall carbon nanotube layer maintains about 99% of the alignment present in the single-wall carbon nanotube array. In other embodiments of the composite material, the single-wall carbon nanotube layer maintains about 97% of the alignment present in the single-wall carbon nanotube array. In other embodiments of the composite material, the single-wall carbon nanotube layer maintains about 95% of the alignment present in the single-wall carbon nanotube array. In other embodiments of the composite material, the single-wall carbon nanotube layer maintains about 90% of the alignment present in the single-wall carbon nanotube array. In other embodiments of the composite material, the single-wall carbon nanotube layer maintains about 80-90% of the alignment present in the single-wall carbon nanotube array. In other embodiments of the composite material, the single-wall carbon nanotube layer maintains about 70-80% of the alignment present in the single-wall carbon nanotube array. In other embodiments of the composite material, the single-wall carbon nanotube layer maintains about 60-70% of the alignment present in the single-wall carbon nanotube array. In other embodiments of the composite material, the single-wall carbon nanotube layer maintains about 50-60% of the alignment present in the single-wall carbon nanotube array. In other embodiments of the composite material, the single-wall carbon nanotube layer maintains about 40-50% of the alignment present in the single-wall carbon nanotube array. In other embodiments of the composite material, the single-wall carbon nanotube layer maintains about 30-40% of the alignment present in the single-wall carbon nanotube array. In other embodiments of the composite material, the single-wall carbon nanotube layer maintains about 20-30% of the alignment present in the single-wall carbon nanotube array. In other embodiments of the composite material, the single-wall carbon nanotube layer maintains about 10-20% of the alignment present in the single-wall carbon nanotube array. In certain embodiments of the method, transferring the single-wall carbon nanotube layer to a polymer maintains alignment of at least a portion of the carbon nanotubes.

### EXAMPLES

The following experimental examples are included to demonstrate particular aspects of the present disclosure. It should be appreciated by those of skill in the art that the methods described in the examples that follow merely represent exemplary embodiments of the disclosure. Those of skill in the art should, in light of the present disclosure, appreciate that many changes can be made in the specific embodiments described and still obtain a like or similar result without departing from the spirit and scope of the present disclosure.

### Example 1

### Measurement of the Compression Factor of Carbon Nanotube Films

Measurement of the degree to which the rolling process compresses the carbon nanotube array was studied with a carbon nanotube array grown in a 25 torr atmosphere comprising C₂H₂, H₂O, and H₂. Growth of the carbon nanotube array to an average of about 613.6 μm tall was achieved in 30 minutes under these growth conditions. After the compressing step, the resulting carbon nanotube film was partially peeled from the substrate in order to measure its thickness. SEM images of the carbon nanotube array before and after compressing are shown in FIG. 2. SEM measurements indicated an average carbon nanotube film thickness in this representative embodiment of about 30.32 μm, which represents over a 20-fold compression of the initial carbon nanotube array. The measured density of the uncompressed carbon nanotube array shown in SEM image 201 is about 20.6 mg/cm³, which gives a density of about 416 mg/cm³ after 20-fold compression. The highly compressed carbon nanotube film retains alignment as verified by SEM image 202 shown in FIG. 2.

### Example 2

### Alignment of Carbon Nanotube Films not Heated with an Etchant

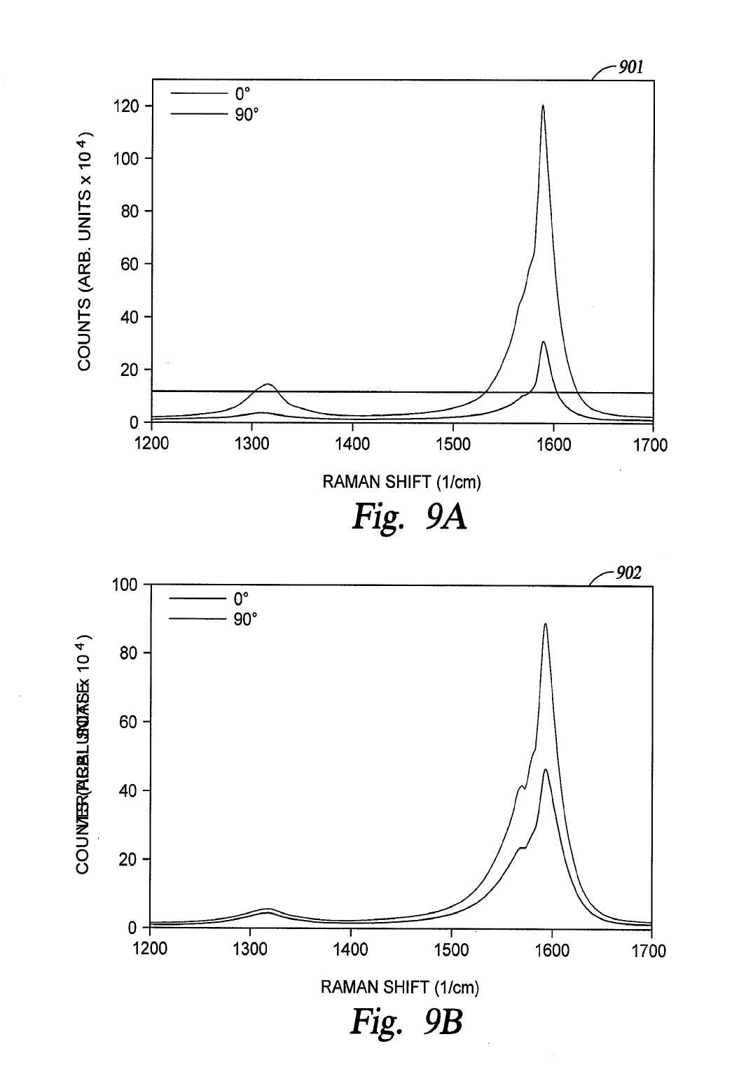

Polarized Raman spectroscopy was utilized to verify retention of carbon nanotube alignment in the film following the compressing step. Polarized Raman spectra for a representative single-wall carbon nanotube array and single-wall carbon nanotube film formed by compressing the array are shown in FIG. 9. In spectrum 901, a 633 nm laser spot was focused on the side of the carbon nanotube array, with the laser light polarization both parallel (0°) and perpendicular (90°) to the direction of carbon nanotube alignment. The absorption of laser light by a single-wall carbon nanotube array decreases as the angle between the laser light polarization and the single-wall carbon nanotube axis approaches 90° . As such, this method provides an estimation of the overall alignment of the single-wall carbon nanotubes comprising the array. As shown in polarized Raman spectrum 901, the ratio between the intensity of the G-band in the parallel (0°) configuration is about 3.9-fold that of the perpendicular configuration, which is typically of aligned single-wall carbon nanotube arrays. Following compressing to form a film and release of the single-wall carbon nanotube film following acid treatment, the ratio of the G-band at 0° and 90° is about 2 as shown in polarized Raman spectrum 902. This result suggests about a 50% loss in alignment in forming the single-wall carbon nanotube film in this manner.

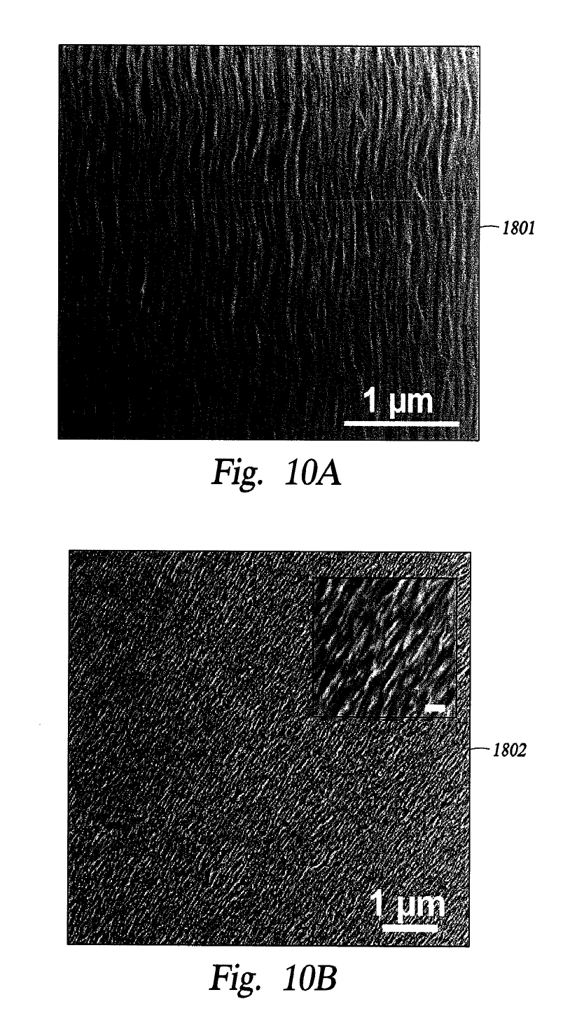

SEM image 1001 of the above single-wall carbon nanotube array shown in FIG. 10 also demonstrates alignment in the single-wall carbon nanotube array prior to the compressing step. In contrast to the polarized Raman spectrum, SEM image 1002 showing a top view of the single-wall carbon nanotube film produced as hereinabove demonstrates retention of alignment of the carbon nanotubes after the compressing step. In this case, the single-wall carbon nanotube film is transferred onto a piece of carbon tape after compression, so SEM image 1002 shows the part of the film that was initially contacting the catalyst surface. It should be noted that measurements of the alignment via polarized Raman spectroscopy may be strongly influenced by the surface single-wall carbon nanotubes in the film, and the inner parts of the film may exhibit a greater degree of alignment as suggested by SEM image 1002.

### Example 3

### Comparison of Single-Wall Carbon Nanotube Arrays not Heated in an Etchant and Single-Wall Carbon Nanotube Arrays Heated in an Etchant

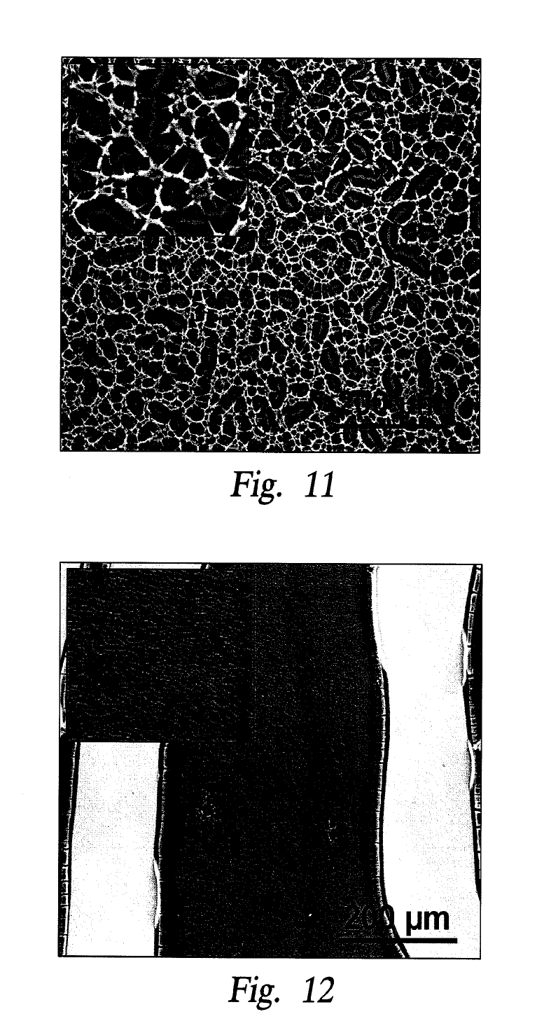

Physical comparison of the two methods for carbon nanotube film removal was performed. In the wet process, the catalyst is etched away from the growth surface by acid to release the carbon nanotube film. In the dry process, heat treatment with a gaseous etchant provides eventual release of the film after the compressing step. First, a comparison of carbon nanotube arrays either treated with an etchant or not treated with an etchant were studied. In order to study the effect of catalyst-film interactions, two identical single-wall carbon nanotube arrays were produced under the growth conditions (2 mins, 750° C.), except that one of them was heated in a gaseous mixture comprising H₂O for 1 minute following growth. The other one was rapidly cooled and removed from the reactor. Following growth, a droplet of water was placed on the top of each single-wall carbon nanotube array and allowed to dry. SEM images of the two arrays after drying are shown in FIGS. 11 (no etchant) and 12 (1 minute treatment with etchant comprising H₂O). It is well known that drying of a liquid after wetting an aligned carbon nanotube array results in the “collapse” of the array into highly dense mesas or cellular structures due to capillary forces between adjacent nanotube bundles as the liquid evaporates. The collapse of the array that was not etched following growth as shown in the FIG. 11 SEM image indicates a typical capillary force-induced drying effect. The FIG. 11 SEM image is composed of small mesas of dense carbon nanotubes that have spider-web like features, indicating that the collapse process occurs by “ripping” the nanotube bundles from the surface. The web-like features are indicative of a strong surface interaction in the process of drying, indicating a strong interaction between the catalyst and carbon nanotubes. For the sample heated for 1 minute in an etchant, a completely different behavior was obtained as shown in the SEM image of FIG. 12. In this case, collapse occurs on a larger scale, with large voids forming between the collapsed regions. This behavior is characteristic of a weakly surface-bound film. This implicates the H₂O vapor etch in altering the bonding of the carbon nanotubes to the growth surface. Weakening of the carbon nanotube contact with the growth surface may allow transfer of the carbon nanotube films to a number of host surfaces.

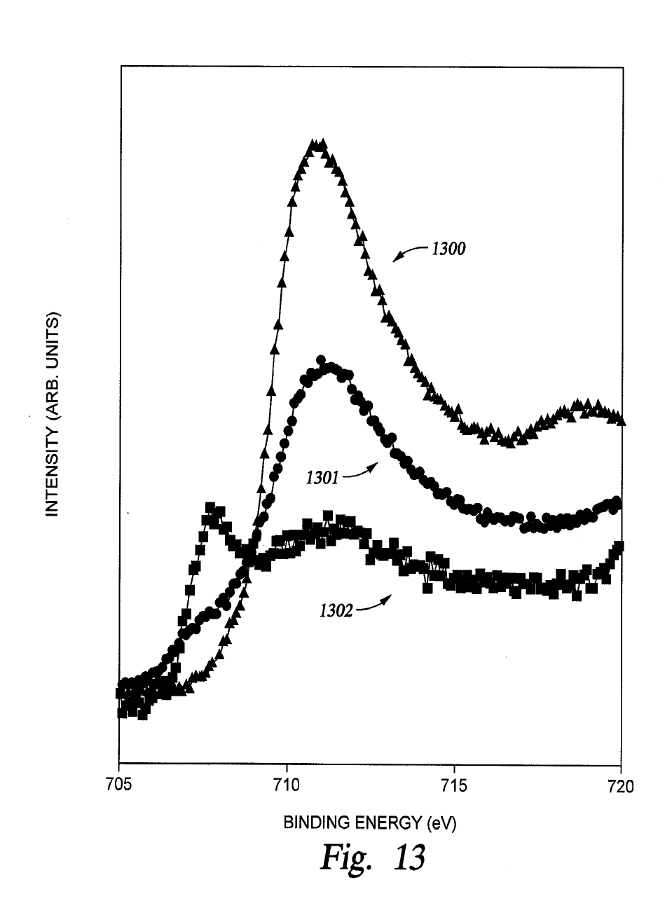

Investigation of the differences between the two carbon nanotube arrays was also investigated by X-ray Photoelectron Spectroscopy (XPS). In most CVD reactor systems used for preparing carbon nanotube arrays, the catalyst coated growth surface is rapidly inserted in a hot furnace to grow, and then rapidly cooled by removing it out of the furnace while the carbon source gas is still flowing. As the Fe catalyst particle of the present example cools, it forms an Fe—C compound comprising a surface segregated carbon shell surrounding the catalyst due to the difference in surface energy between Fe and C. Following removal from the hot furnace, the carbon nanotubes in the array are fixed to the catalyst particle by C—C bonds to the C shell, which is in turn bound to the catalyst particle through mixed Fe—C bonds. As a result, the initially produced carbon nanotube array is strongly bound to the growth surface. Further, the tight binding explains why the compressing step of an array which has not been heated in the presence of an etchant leaves the carbon nanotube film intact on the growth surface rather than transferred to the roller. Acid treatment removes the Fe catalyst layer from the growth surface and releases the intact carbon nanotube film. When the as-produced carbon nanotube array is exposed at a high temperature (775° C.) to an etchant, the carbon in the catalyst particle is precipitated out and etched away by the H₂O, while the catalyst particle is re-oxidized. Mechanical stresses in the film apparently aid in the “pop-off” mechanism of the nanotube array from the oxidized catalyst, explaining the facile removal of carbon nanotube films by contact with another surface. This picture is supported by the XPS data shown in FIG. 13, which shows three core-level Fe spectral lines. Spectrum 1300 is a reference Fe/Al₂O₃/Si catalyst spectrum. Spectra 1301 and 1302 are for catalyst layers from carbon nanotube arrays obtained after carbon nanotube array growth and etching (1301) and after carbon nanotube array growth without etching (1302). In spectra 1301 and 1302, the samples were placed in XPS system following limited air exposure (less than 2-3 minutes). XPS spectra in FIG. 13 are presented with binding energy values relative to the core level adventitious carbon peak, located at 285.0 eV. The Fe2P_{3/2} core-level peak positions for Fe with no growth, as well as the Fe after growth and H₂O etching and film removal, are in the same vicinity of highly oxidized Fe (Fe₂O₃) with core-level peaks fit to Gaussians with centers near 711.0 eV. However, the Fe2P_{3/2} spectra for the array that is grown and cooled in acetylene before removal with no etching, has a spectrum with a core-level binding energy peak fit to 707.8 eV. This is too high for metallic Fe, and best corresponds to the formation of a Fe—C compound, as the binding energy for Fe₃C is at 708.1 eV. There are many possible Fe-C states. This supports the hypotheses detailed hereinabove describing different states of the catalyst in the two cases of film removal.

From the foregoing description, one skilled in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure, which is defined in the following claims.

What is claimed is:

1. A method for producing a carbon nanotube layer, comprising:
compressing an array, wherein said array comprises a plurality of carbon nanotubes, and wherein compressing said array comprises passing a roller over said array.

2. The method of claim 1, wherein said layer comprises a film.

3. The method of claim 1, wherein said layer comprises a ribbon.

4. The method of claim 1, wherein at least a portion of said plurality of carbon nanotubes comprising said array are vertically aligned.

5. The method of claim 4, wherein said carbon nanotubes comprise at least one component selected from the group consisting of single-wall carbon nanotubes, double-wall carbon nanotubes, multi-wall carbon nanotubes, and combinations thereof.

6. The method of claim 5, wherein at least a portion of the carbon nanotubes comprising the carbon nanotube layer are aligned.

7. The method of claim 6, further comprising transferring the carbon nanotube layer to a host surface.

8. The method of claim 7, wherein said transferring maintains alignment of at least a portion of said carbon nanotubes.

9. A method for preparing a carbon nanotube layer, wherein said layer comprises a plurality of aligned carbon nanotubes, and wherein said method comprises the steps of:
a) preparing an array, wherein said array comprises a plurality of vertically aligned carbon nanotubes;
b) cooling said array in a gaseous mixture comprising a carbon source and H₂O;
c) compressing said array with a roller to create a carbon nanotube layer, wherein said layer comprises a plurality of aligned carbon nanotubes; and
d) treating said layer with an acid.

10. The method of claim 9, wherein said layer comprises a film.

11. The method of claim 9, wherein said layer comprises a ribbon.

12. The method of claim 9, wherein step (a) takes place in the presence of a metallic catalyst.

13. The method of claim 9, wherein said carbon nanotubes comprise single-wall carbon nanotubes.

14. A method for preparing a carbon nanotube layer, wherein said layer comprises a plurality of aligned carbon nanotubes, and wherein said method comprises the steps of:
a) preparing an array, wherein said array comprises a plurality of vertically aligned carbon nanotubes;
b) heating said array in a gaseous mixture comprising an etchant; and
c) compressing said array with a roller to create a carbon nanotube layer, wherein said layer comprises a plurality of aligned carbon nanotubes.

15. The method of claim 14, wherein said layer comprises a film.

16. The method of claim 14, wherein said layer comprises a ribbon.

17. The method of claim 14, wherein step (a) takes place in the presence of a metallic catalyst.

18. The method of claim 14, wherein said etchant comprises H₂O.

19. The method of claim 14, wherein said carbon nanotubes comprise single-wall carbon nanotubes.

20. The method of claim 14 further comprising:
d) transferring said layer.

21. The method of claim 20, wherein said transferring occurs during the compressing step, and said transferring is to a host surface covering said roller.

22. A method for preparing a carbon nanotube layer, wherein said layer comprises a plurality of aligned carbon nanotubes, and wherein said method comprises the steps of:
a) preparing a carbon nanotube growth surface, wherein said growth surface comprises a grouping of lines comprising a metallic catalyst;
b) growing an array, wherein said array comprises a plurality of vertically aligned carbon nanotubes, wherein said growing occurs on said grouping of lines, and wherein the height of said plurality of vertically aligned carbon nanotubes is greater than the separation between lines in said grouping of lines; and
c) compressing said array with a roller to create a carbon nanotube layer, wherein said layer comprises a plurality of aligned carbon nanotubes.

23. The method of claim 22, wherein said layer comprises a film.

24. The method of claim 22, wherein said layer comprises a ribbon.

25. The method of claim 22 further comprising heating said array in a gaseous mixture comprising an etchant prior to step (c).

26. The method of claim 25, wherein said etchant comprises H₂O.

27. The method of claim 22 further comprising:
d) removing said layer from said growth surface.

28. The method of claim 22, wherein at least a portion of said carbon nanotubes are aligned following said compressing step.

29. The method of claim 22, wherein said carbon nanotubes comprise single-wall carbon nanotubes.

30. A composite material comprising at least one single-wall carbon nanotube layer, wherein said layer comprises a plurality of aligned single-wall carbon nanotubes, and wherein said composite material is prepared by the process comprising the steps of
a) preparing an array, wherein said array comprises a plurality of vertically aligned single-wall carbon nanotubes;
b) heating said array in a gaseous mixture comprising an etchant;
c) compressing said array with a roller to create a carbon nanotube layer, wherein said layer comprises a plurality of aligned single-wall carbon nanotubes; and
d) transferring said layer to a polymer.

31. The composite material prepared by the process of claim 30, wherein said etchant comprises H₂O.

32. The composite material prepared by the process of claim 30 further comprising coating said roller with a polymer film prior to step (c).

33. The composite material prepared by the process of claim 30 further comprising alternating sheets of polymer film and single-wall carbon nanotube layers.
